(19) United States
(12) Patent Application Publication
(10) Pub. No.: US 2013/0185233 A1
(43) Pub. Date: Jul. 18, 2013

(54) SYSTEM AND METHOD FOR LEARNING POSE CLASSIFIER BASED ON DISTRIBUTED LEARNING ARCHITECTURE

(71) Applicant: SAMSUNG ELECTRONICS CO., LTD., Suwon-si (KR)

(72) Inventors: Byung In YOO, Seoul (KR); Chang Kyu CHOI, Sungnam-si (KR); Jae Joon HAN, Seoul (KR); Chang Kyo LEE, Yongin-si (KR)

(73) Assignee: SAMSUNG ELECTRONICS CO., LTD., Suwon-si (KR)

(21) Appl. No.: 13/740,597

(22) Filed: Jan. 14, 2013

(30) Foreign Application Priority Data
Jan. 16, 2012 (KR) 10-2012-0004685

(51) Int. Cl. G06N 99/00

(52) U.S. Cl. CPC G06N 99/005
USPC 706/12

(57) ABSTRACT

A system and method for learning a pose classifier based on a distributed learning architecture. A pose classifier learning system may include an input unit to receive an input of a plurality of pieces of learning data, and a plurality of pose classifier learning devices to receive an input of a plurality of learning data sets including the plurality of pieces of learning data, and to learn each pose classifier. The pose classifier learning devices may share learning information in each stage, using a distributed/parallel framework.

### CROSS-REFERENCE TO RELATED APPLICATIONS

This application claims the priority benefit of Korean Patent Application No. 10-2012-0004685, filed on Jan. 16, 2012, in the Korean Intellectual Property Office, the disclosure of which is incorporated herein by reference.

### BACKGROUND

1. Field

Example embodiments of the following description relate to a system and method for learning a pose classifier based on a distributed learning architecture, and more particularly, to a technology of learning a classifier enabling recognition of a pose of an object in a distribution system.

2. Description of the Related Art

Recently, research and development relating to a technology of sensing a movement of a user's body and controlling a user interface (UI) based on the sensed movement is accelerating.

In an AdaBoost, and the like, a classifier using thousands of learning images as inputs is typically used. However, a recently emerged classifier, such as a random forest, is required to be learned using at least hundreds of thousands of learning images as inputs.

However, generally, the operation of learning requires a large amount of time and a large capacity of memory, as compared to the classification and recognition operations.

For example, to learn a million 4-channel images with a size of “320×240” each, a memory of about 250 gigabytes (GB) (226 kilobytes (KB)×1,000,000) may be required. Additionally, when a million images are learned using a general-purpose personal computer (PC) that employs a single core and a single thread, a period of time of about 27 years may be required. However, a time of 30 milliseconds (msec) or less may typically be required to classify, in real-time, input images using a learned classifier.

The size of the global film market was estimated in 2007 to have revenues of about 85.9 billion dollars, including revenues of 27.4 billion dollars from films released in theaters, 55.8 billion dollars from home videos, such as DVDs, for example, and 2.7 billion dollars from on-line videos. The size of the U.S. film market was estimated to have revenues of about 33.7 billion dollars, and the size of the Western Europe film market was estimated to have revenues of about 22.2 billion dollars.

The size of the global film market is similar to the size of the global gaming market, which was estimated in 2007 to have revenues of about 86.4 billion dollars including 35.8 billion dollars for arcade games, 3.0 billion dollars for personal computers (PCs), 37.4 billion dollars for game consoles, 7.2 billion dollars for on-line games, and 2.9 billion dollars for mobile games. A UI technology based on body movements is likely to be actively used to control interactive video, as well as, used for current graphic-based games. Accordingly, when a music video market, a music broadcasting market, and a health video market are added, an importance of worth of a technology to control interactive video may be further increased.

### SUMMARY

The foregoing and/or other aspects are achieved by providing a pose classifier learning system, including an input unit to receive an input of a plurality of pieces of learning data, and a plurality of pose classifier learning devices to receive an input of a plurality of learning data sets including the plurality of pieces of learning data, and to learn each pose classifier, wherein the pose classifier learning devices share learning information in each stage, using a distributed/parallel framework.

The foregoing and/or other aspects are achieved by providing an operation method of a pose classifier learning system, including receiving an input of a plurality of pieces of learning data, and receiving, by a plurality of pose classifier learning devices, an input of a plurality of learning data sets including the plurality of pieces of learning data, and learning each pose classifier, wherein the pose classifier learning devices share learning information in each stage, using a distributed/parallel framework.

The foregoing and/or other aspects are achieved by providing a method for reducing a learning time for learning images, the method including: reading, by a processor, a learning target by extracting a data portion from each of a plurality of pieces of image data; storing the learning target in a data structure for learning; and learning, in parallel by each of a plurality of pose classifier learning devices, a single pose classifier, using the read learning target.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of a pose classifier learning system, according to example embodiments;

FIG. 2 illustrates a diagram of a structure of a pose classifier learning system in which a plurality of processes generate a single classifier, according to example embodiments;

FIG. 3 illustrates a diagram of a structure in which a single process loads input data from a single directory, and learns the loaded input data, according to example embodiments;

FIG. 4 illustrates a diagram of a structure in which one of a plurality of processes corresponds to a coordinator, and in which the other processes participate, as attendees, in message communication, according to example embodiments;

FIGS. 5 and 6 illustrate diagrams of an order of messages that are exchanged between a plurality of processes to generate a single recognizer, according to example embodiments;

FIG. 7 illustrates a diagram to explain a method of selecting only a portion of learning data and learning the selected portion, according to example embodiments;

FIG. 8 illustrates a diagram to explain a method of learning all important parts of an object in learning data, partially selecting the other parts and learning the selected part, according to example embodiments;

FIG. 9 illustrates a diagram of a data structure in which learning data is loaded above an actual memory, according to example embodiments;

FIG. 10 illustrates a diagram to explain a method of transferring learning data when a single classifier is generated by a plurality of processes, according to example embodiments;

FIG. 11 illustrates a graph to explain a method of determining how many number of iterations are required to acquire an optimized learning result in each stage during generation of a single classifier, according to example embodiments;

FIG. 12 illustrates a flowchart of the method of FIG. 7;

FIG. 13 illustrates a flowchart of the method of FIG. 8;

FIG. 14 illustrates a flowchart of processing of residual learning data according to example embodiments;

FIG. 15 illustrates a flowchart of the method of FIG. 11; and

FIG. 16 illustrates a flowchart to further explain stopping criteria associated with learning of a pose classifier, according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

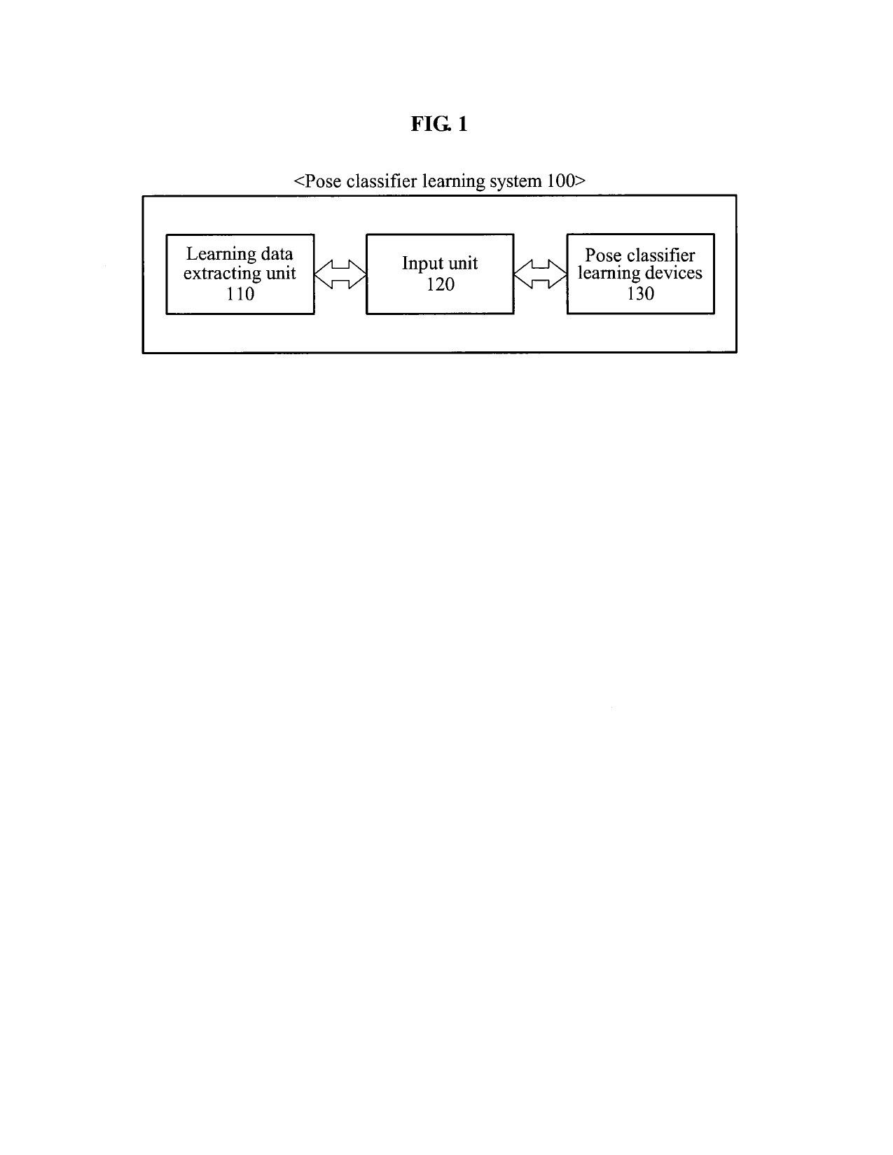

FIG. 1 illustrates a block diagram of a pose classifier learning system 100, according to example embodiments.

The pose classifier learning system 100 of FIG. 1 may minimize memory usage and learning time that is required for learning, and may ensure a required recognition performance using a classifier obtained by the learning, so that at least hundreds of thousands of images may be simultaneously learned.

The pose classifier learning system 100 of FIG. 1 may include a learning data extracting unit 110, an input unit 120, and a plurality of pose classifier learning devices 130. The learning data extracting unit 110, the input unit 120, and the plurality of pose classifier learning devices 130 may each include one or more processing devices.

The learning data extracting unit 110 may extract a plurality of pieces of learning data from a plurality of pieces of image data.

The input unit 120 may receive an input of the extracted plurality of pieces of learning data.

The pose classifier learning devices 130 may receive an input of a plurality of learning data sets including the plurality of pieces of learning data, and may learn each pose classifier. Additionally, the pose classifier learning devices 130 may share learning information in each stage, using a distributed/parallel framework.

The learning data extracting unit 110 may extract, as the plurality of pieces of learning data, at least one data portion corresponding to a vertical line, a horizontal line, and a diagonal line, among data portions of each of the plurality of pieces of image data.

Therefore, the pose classifier learning devices 130 may reduce the required learning time by minimizing the memory usage, thereby making it possible to improve the performance of the pose classifier by the learned classifier.

In addition, the learning data extracting unit 110 may apply a weight to the extracted plurality of pieces of learning data.

For example, the learning data extracting unit 110 may apply more weight to an end part of a body with a large movement, such as, hands, arms, a head, and the like, as compared to a part of the body with a minimal movement, such as, a trunk of the body, and may control the end part of the body to be learned.

The pose classifier learning devices 130 may simultaneously learn the plurality of pieces of learning data, using a data structure in which only effective data required for distributed learning is managed in a physical memory.

Additionally, the pose classifier learning devices 130 may simultaneously learn the plurality of pieces of learning data, using a structure in which only effective data required for distributed learning is transferred to each stage of the learning.

Furthermore, the pose classifier learning devices 130 may dynamically adjust, based on a number of stages of the learning, a number of iterations to search for an optimized result in each learning stage of the pose classifier.

Moreover, the pose classifier learning devices 130 may determine whether or not the learning is to proceed to a next stage, based on at least one of an entropy of residual learning data, an amount of the residual learning data, and a progress of the learning.

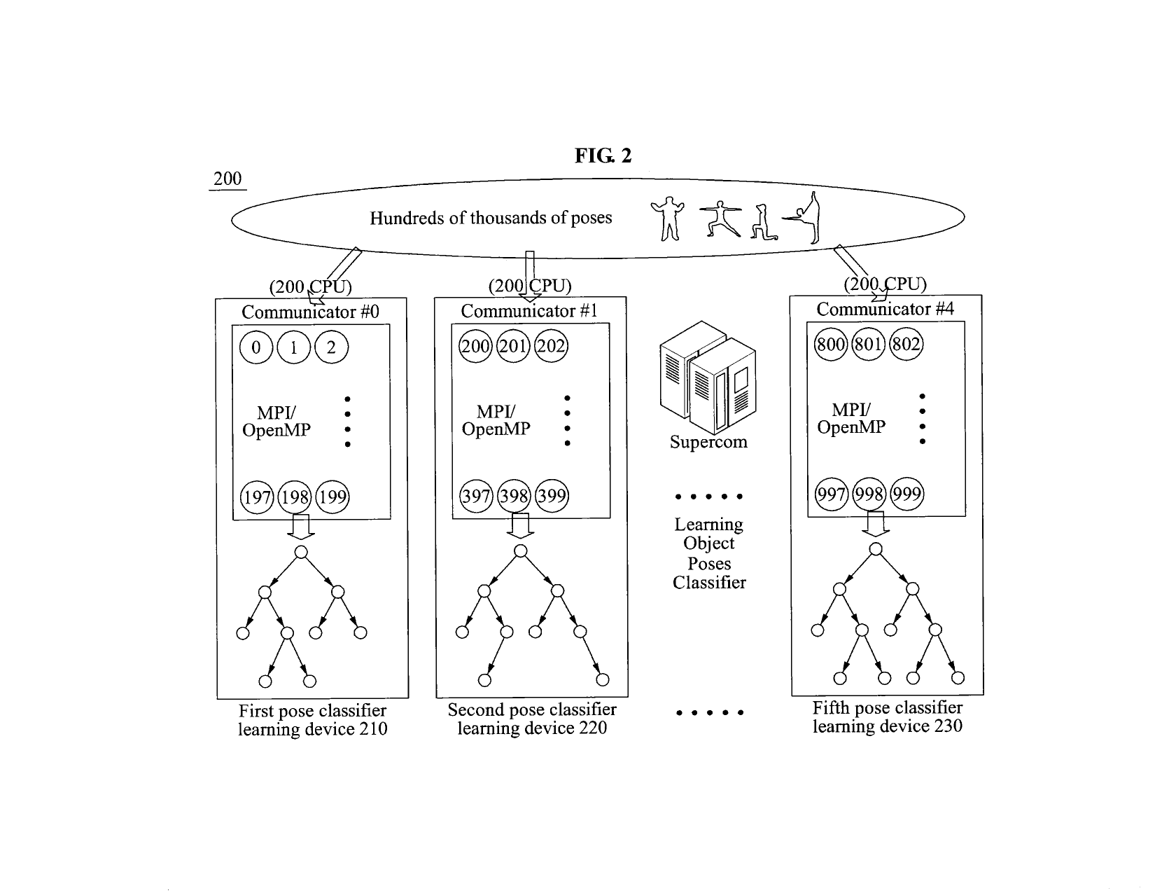

FIG. 2 illustrates a diagram of a structure 200 of a pose classifier learning system in which a plurality of processes generate a single classifier, according to example embodiments.

Specifically, to learn a large amount of input data, e.g., over hundreds of poses, using a supercomputer, a plurality of processes may generate a single pose classifier. For example, in the structure 200 of FIG. 2, the two hundred processes of processes 0 to 199 may generate a single pose classifier. The use of two hundred processes to generate a single pose classifier is an example, and thus, the present disclosure is not limited thereto.

In an example embodiment, the two hundred processes may be allocated to jobs processed by pose classifier learning devices, and thus, a pose classifier may be learned.

For example, the pose classifier learning system may execute five jobs using a total of five pose classifier learning devices, such as, a first pose classifier learning device 210, a second pose classifier learning device 220, a fifth pose classifier learning device 230, and the like.

In this instance, the pose classifier may include, for example, a decision tree, or a random forest including a plurality of decision trees.

In another example embodiment, the pose classifier may be an AdaBoost classifier including a plurality of weak classifiers.

In yet another example embodiment, the pose classifier may be a random fern classifier including at least tens of classifiers with low level.

In example embodiments, a distributed learning method of an object pose recognition may be provided without a limitation to a predetermined classifier.

As shown in the structure 200 of FIG. 2, a single classifier may be learned through a single job.

For example, when a total of eight processors exist in a single physical system, a single processor may perform a single process.

Typically, in the structure 200 of the pose classifier learning system, communication and sharing of information may be performed between processes using a Message Passing Interface (MPI) during the learning.

However, a parallel execution framework, such as an Open Multi-Processing (OpenMP), may be used between processes of physical system inbound, and a distributed communication framework, such as, an MPI, may be used between processes of a physical system outbound.

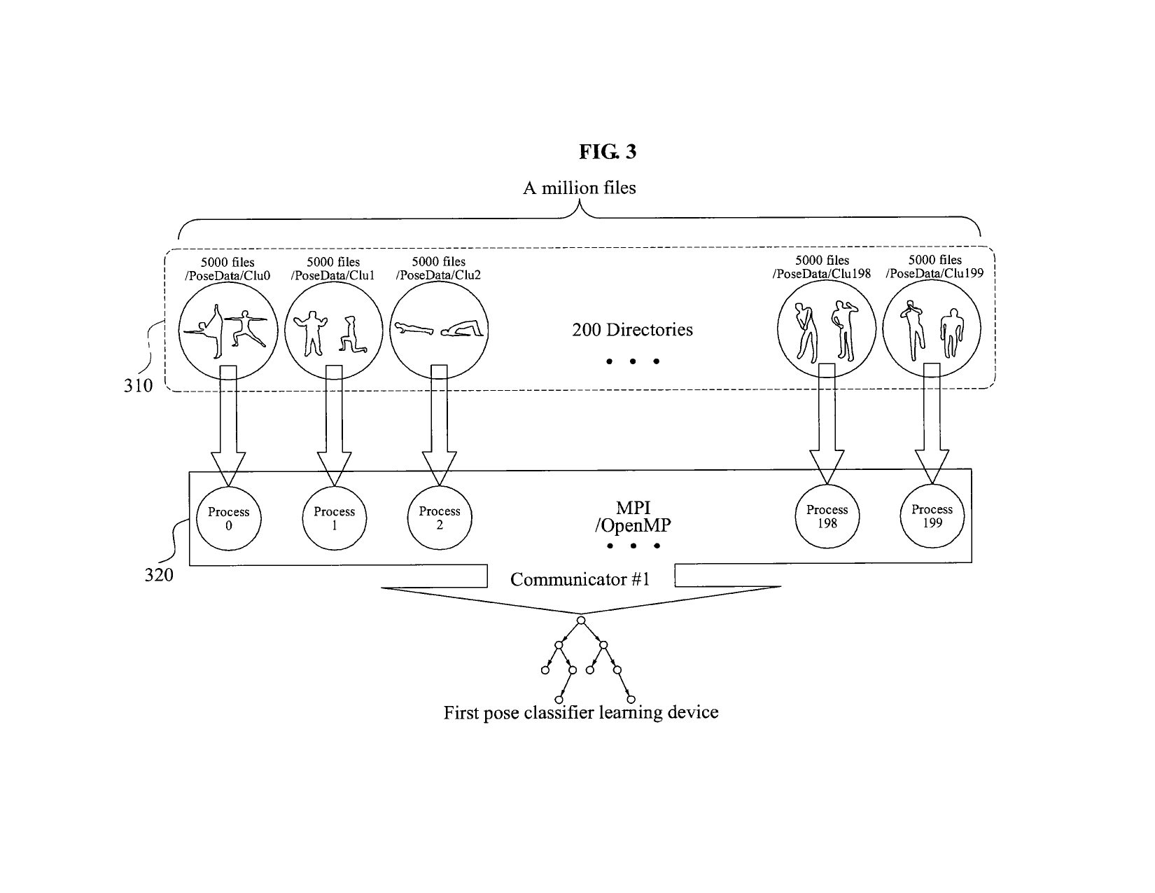

FIG. 3 illustrates a diagram of a structure, in which a single process loads input data from a single directory, and learns the loaded input data, according to example embodiments.

In FIG. 3, a large amount of input data, for example, over hundreds of thousands of poses, may be divided and stored in a plurality of directories, and a single process may load input data from a single directory, among the plural directories, and may learn the loaded input data. For example, as shown in FIG. 3, each of the two hundred directories includes 5000 files.

In the structure of FIG. 3, the two hundred processes 0 to 199 processed by a single pose classifier learning device may share a single MPI communicator, to share information.

Individual processes may learn a part of all image files. For example, when a million image files 310 exist, each of the two hundred processes 320 may learn the 5000 files of each directory.

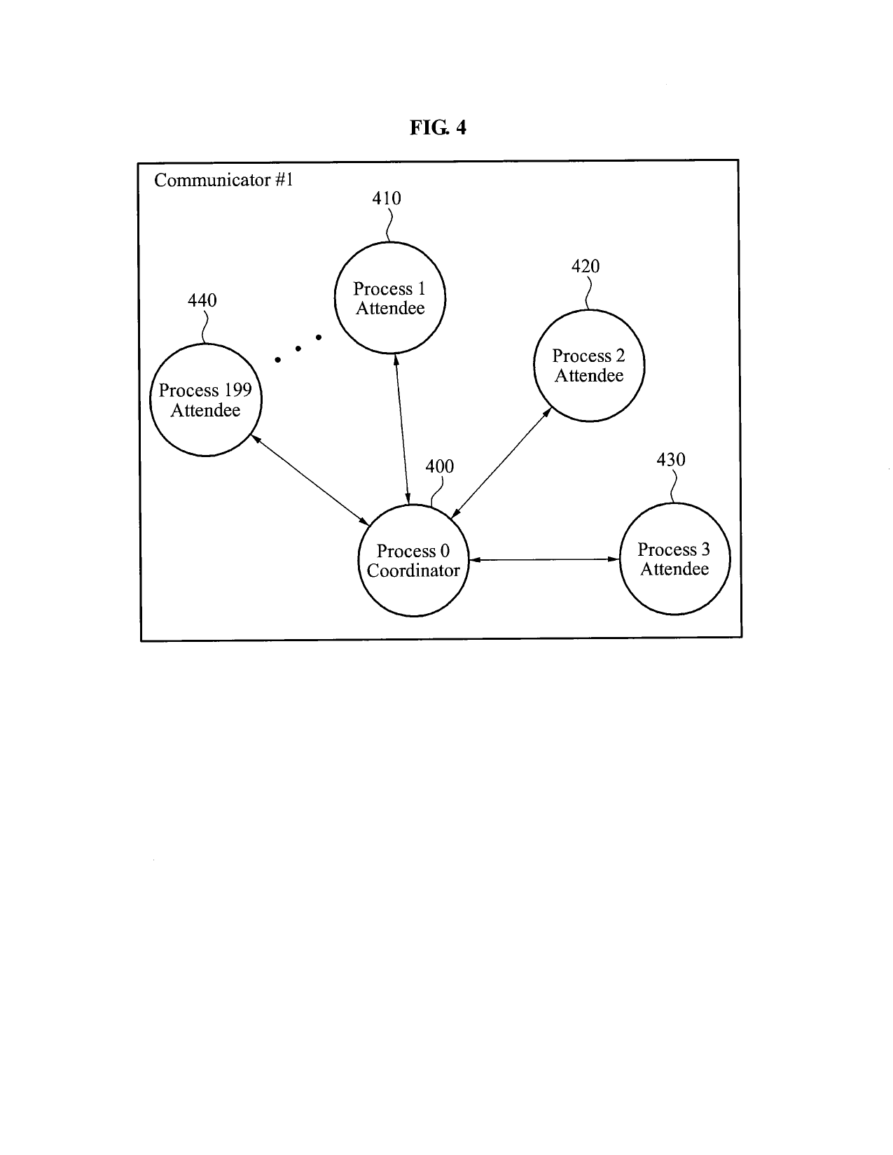

As shown in FIG. 4, in each MPI communicator, the process 0 coordinator 400 may function as a coordinator, and the other processes, for example process 1 attendee 410, process 2 attendee 420, process 3 attendee 430, process 199 attendee 440, and the like, may function as attendees.

FIG. 4 illustrates a diagram of a structure, in which one of a plurality of processes corresponds to a coordinator, and in which the other processes participate, as attendees, in message communication, according to example embodiments of the present disclosure.

The coordinator, e.g. process 0 coordinator 400, may function as a hub of message passing with all attendees as well as the coordinator, and may guarantee a message to have a fault tolerance.

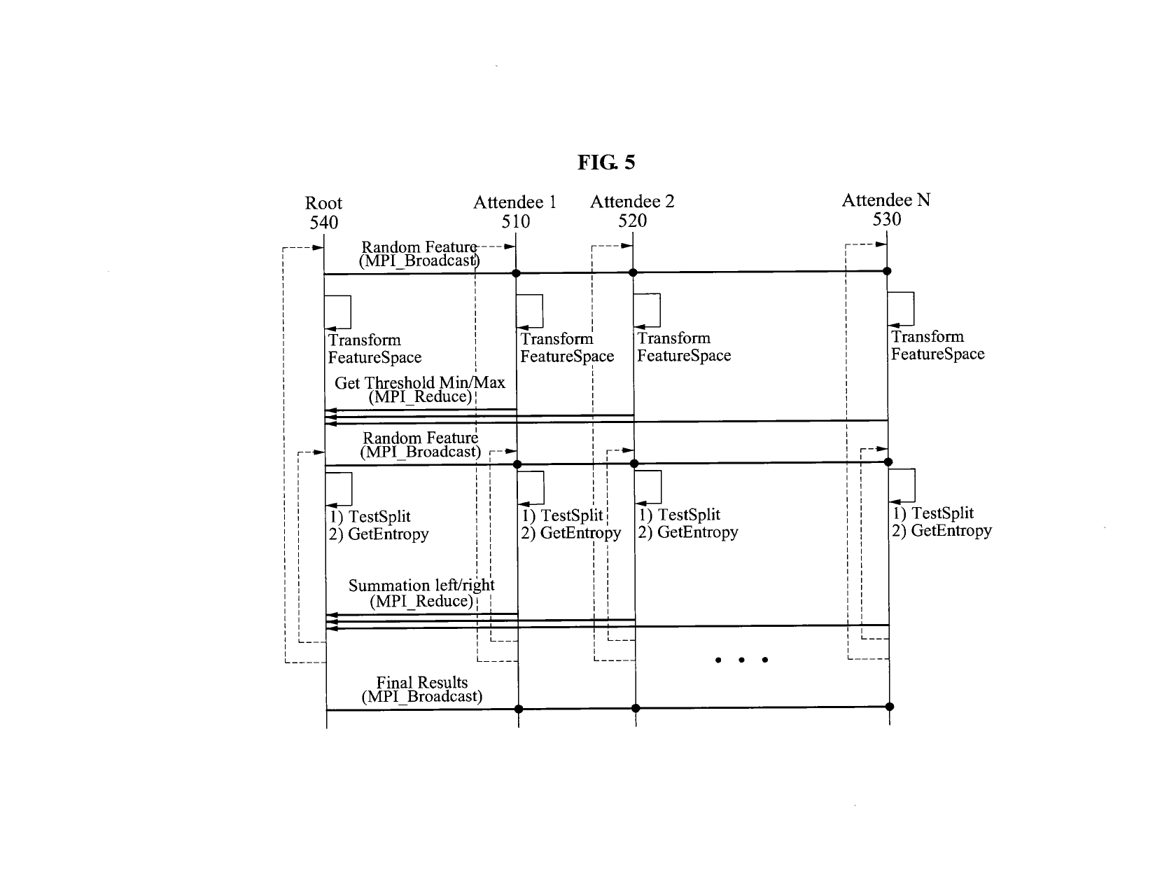

A pose classifier learning device, according to example embodiments, may transfer a plurality of messages between processes, and may generate a pose classifier. For example, when a pose classifier is generated as a decision tree, messages may be transferred between a root 540 and each of attendees 510, 520, and 530, in an order shown in FIG. 5.

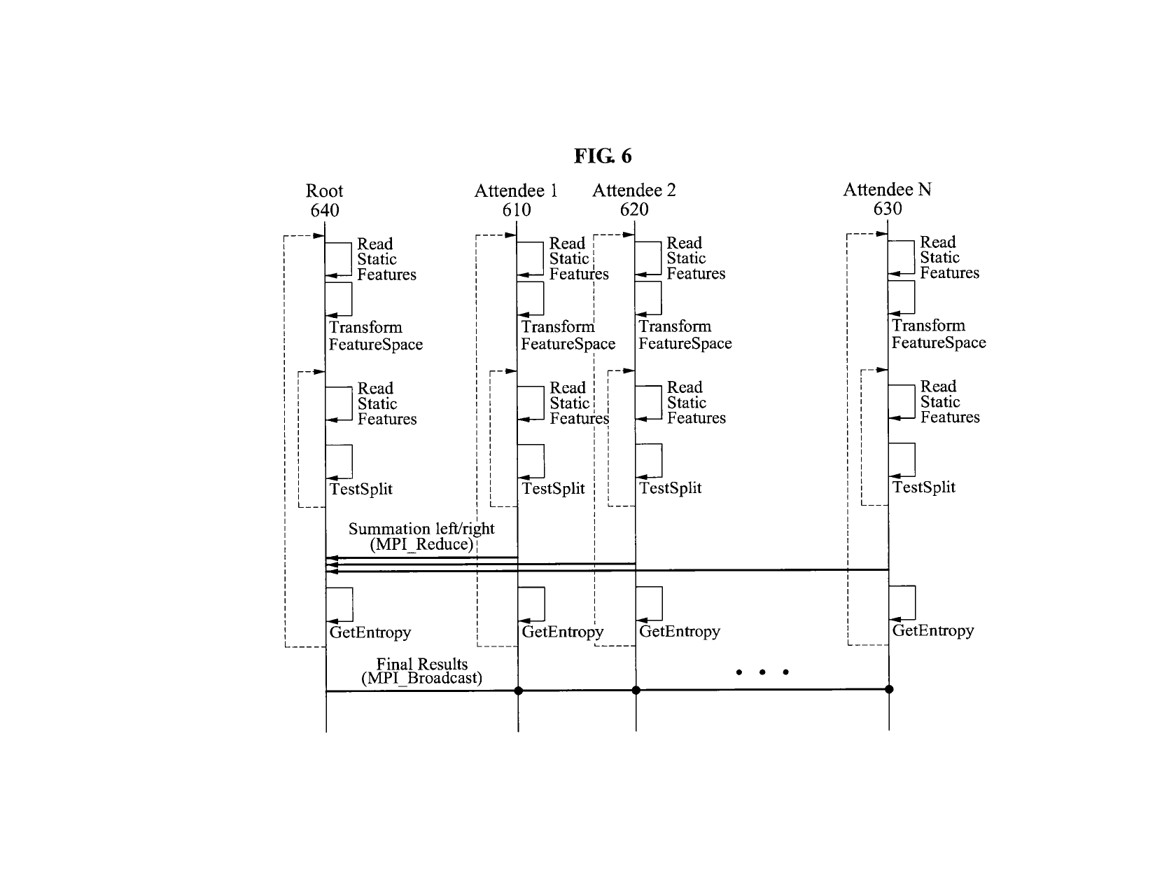

In this instance, to minimize a number of messages to be exchanged, the same information may be generated in advance. When the same information is used by each process, a number of messages transferred between a root 640 and each of attendees 610, 620 and 630, as shown in FIG. 6, may be reduced. Thus, it is possible to minimize a time required to learn a pose classifier.

For reference, FIGS. 5 and 6 illustrate diagrams of an order of messages that are exchanged between a plurality of processes to generate a single recognizer, according to example embodiments.

A decision tree used as a pose classifier may have a plurality of nodes. Each of the nodes may be called by a recursive call, to learn the decision tree. In each of the nodes, an optimized learning result may be acquired using a process described below.

When a value calculated by a split function f of a data portion is less than a threshold value t, an input feature vector v obtained from a depth image may be split to the left, as shown in Equation 1 below. When the value is greater than the threshold value t, the input feature vector v may be split to the right.

Iₗ={i ∈ Iₙ|f(vᵢ)<t}

Iᵣ=Iₙ/Iₗ

In Equation 1, Iₗ denotes learning data of an input depth image split to the left, and Iᵣ denotes learning data of an input depth image split to the right.

In each of the nodes, an information gain that is split to the left and the right using a random split feature function and a random threshold, may be measured by a Shannon's entropy. In this instance, a threshold and a feature of minimizing an entropy gain may be stored as properties of a corresponding node. However, the use of Shannon's entropy is an example, and thus, the present disclosure is not limited thereto.

An entropy gain ΔE maximized by Iₗ or Iᵣ may be represented, as given in the following Equation 2:

$$Δ E = - \frac{\vert {I}_{l} \vert}{\vert {I}_{n} \vert} E ( {I}_{l} ) - \frac{\vert {I}_{r} \vert}{\vert {I}_{n} \vert} E ( {I}_{r} ) \qquad [ Equation 2 ]$$

A range t of the threshold may be limited, as given in Equation 3 below. In other words, the range of the threshold may be determined to be a range between a maximum value and a minimum value of a split function calculated using a given feature vector.

t ∈ (minᵢ f(vᵢ), maxᵢ f (v₂))

In this instance, a single random forest including a plurality of decision trees may be used as a pose classifier.

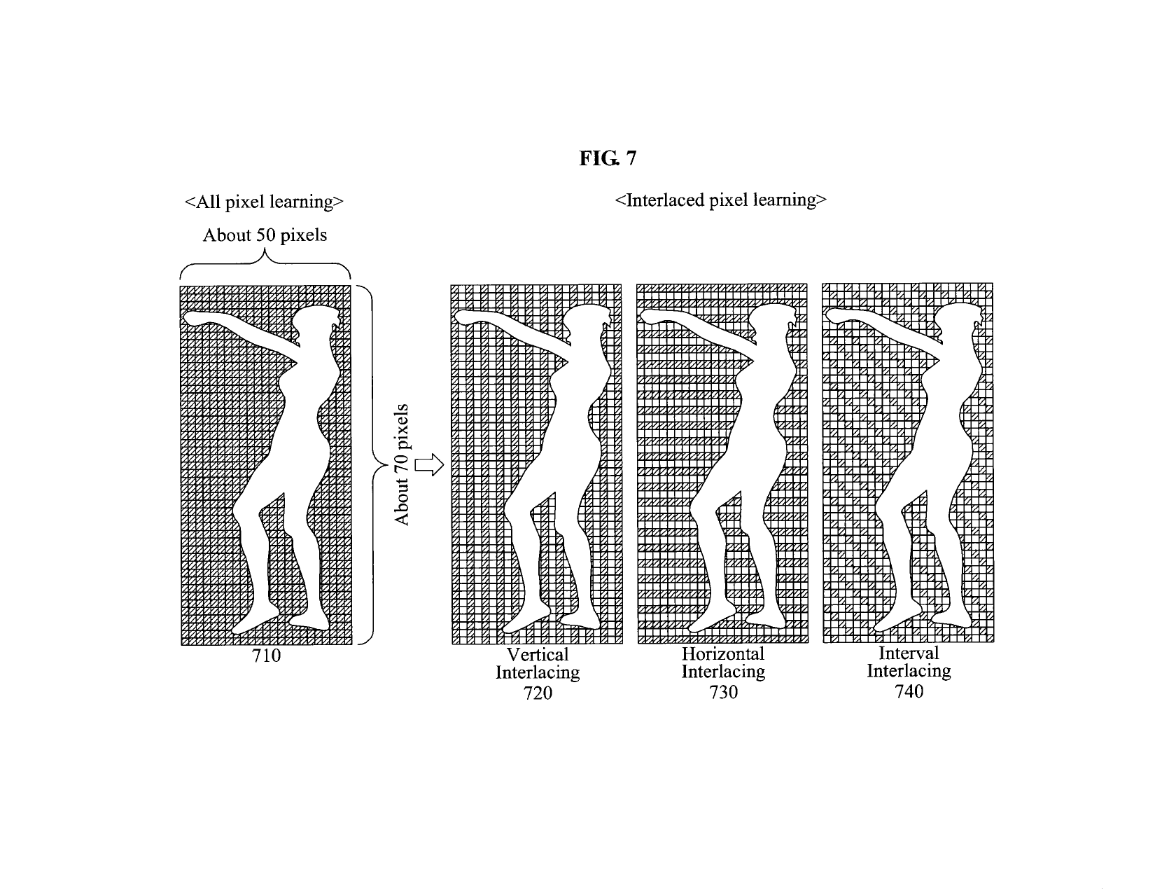

FIG. 7 illustrates a diagram to explain a method of selecting only a portion of learning data and learning the selected portion, according to example embodiments.

A pose classifier learning system, according to example embodiments, may select, as learning data, data of a learning target, instead of learning all data in an image 710.

In an example, the pose classifier learning system may learn only a portion of data corresponding to a line selected based on a vertical line, as indicated by a reference numeral 720, or may learn only a portion of data corresponding to a line selected based on a horizontal line, as indicated by a reference numeral 730.

In another example embodiment, the pose classifier learning system may learn only a portion of data corresponding to a selected line, by skipping a designated number of portions of the data while reading the data from an upper left side to a right side, as indicated by a reference numeral 740. The above embodiments are intended to be exemplary, and thus, the present disclosure is not limited thereto.

Therefore, by learning a portion of the data, the pose classifier learning system may reduce the required learning time, and may maintain a recognition performance.

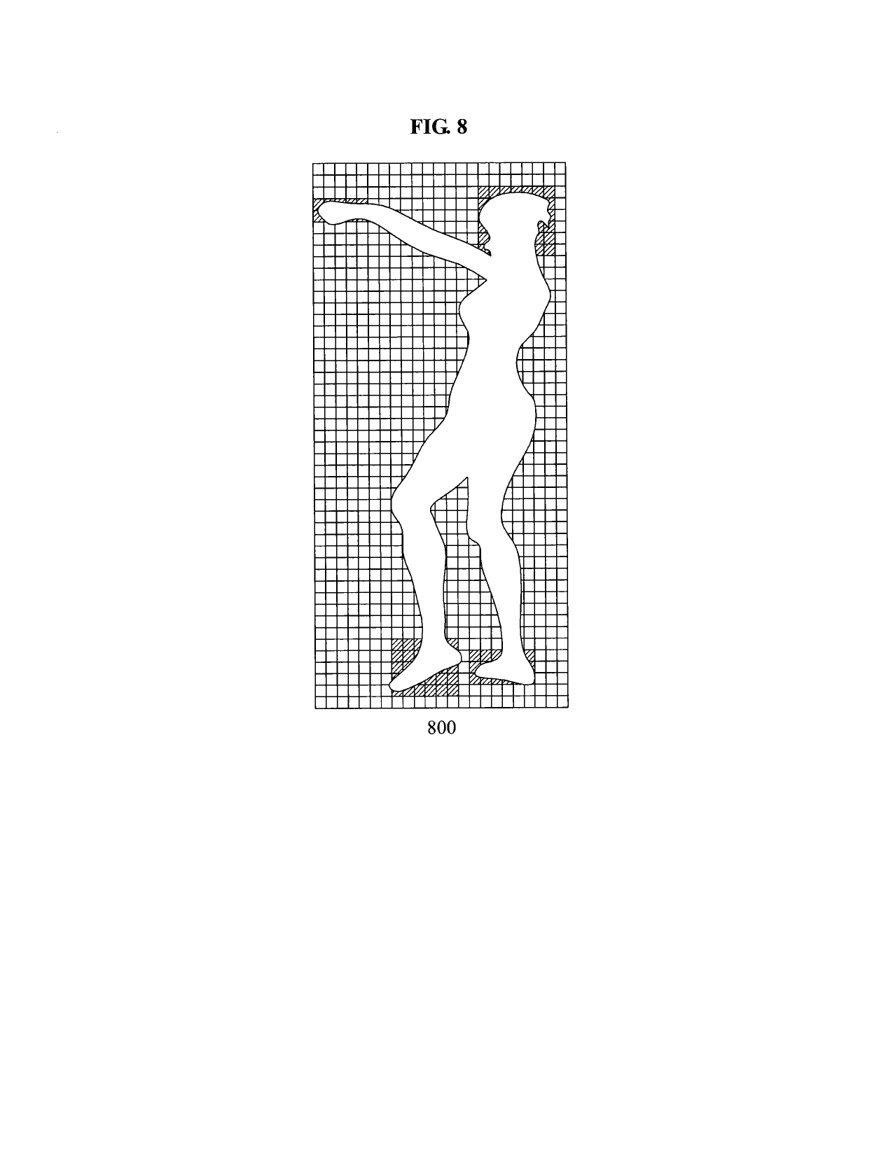

FIG. 8 illustrates a diagram to explain a method of learning all important parts of an object in learning data, partially selecting the other parts and learning the selected part, according to example embodiments.

A pose classifier learning system, according to example embodiments, may learn all important data regarding a part of a body, for example, hands or feet, and may learn only a portion of the other data, for example, a trunk of the body, and the like, using the method of FIG. 7. Accordingly, the learning time may be reduced, and a recognition rate of important body parts may be improved.

For example, data regarding a body part that frequently moves may be determined to be the important data. Additionally, data regarding a body part with a relatively small proportion of a body may be determined to be the important data. The above description of important data is an example, and thus, the present disclosure is not limited thereto.

Additionally, when an entropy is calculated, higher weights may be applied to important body parts, and lower weights may be applied to the other body parts, and thus, it is possible to improve a recognition rate of the important body parts.

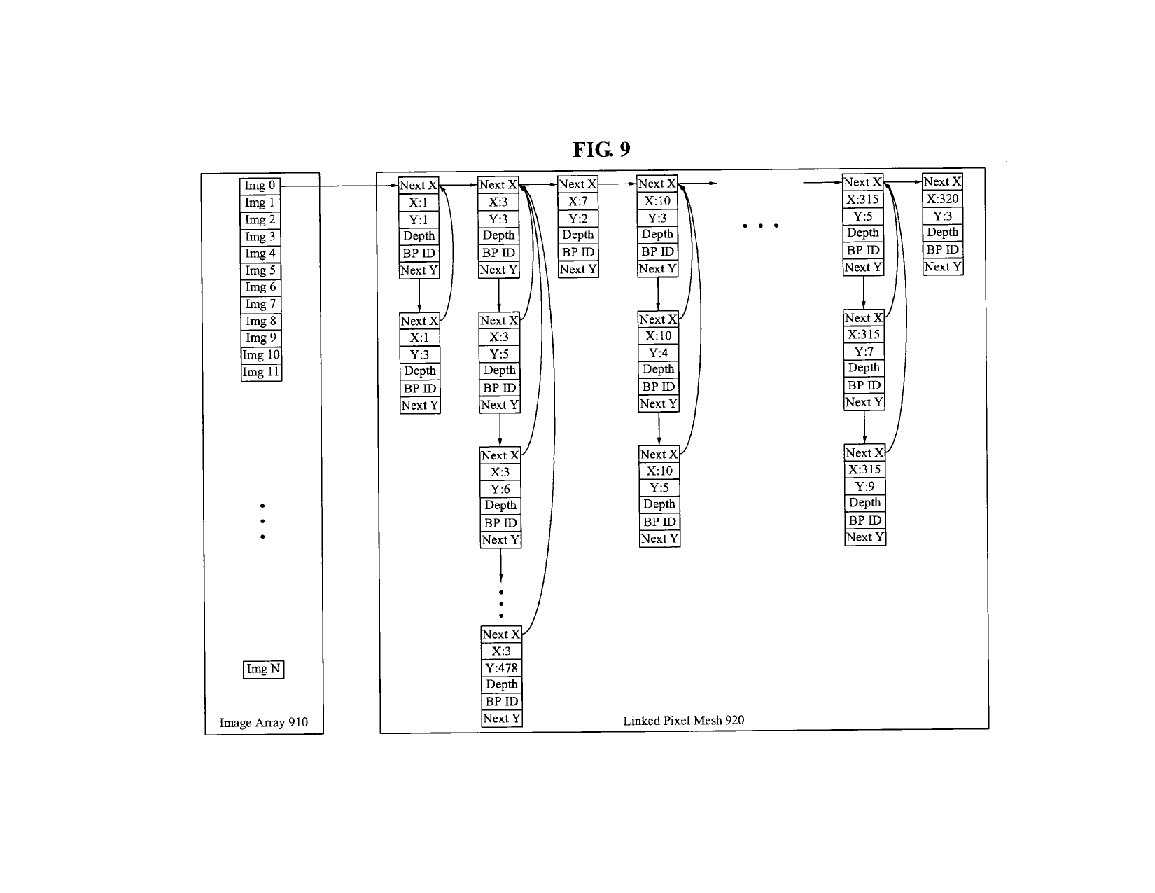

FIG. 9 illustrates a diagram of a data structure, in which learning data is loaded above an actual memory, according to example embodiments.

A pose classifier learning system, according to example embodiments, may simultaneously learn a plurality of pieces of learning data, using a data structure in which only effective data required for distributed learning is managed in a physical memory.

FIG. 9 illustrates a physical memory structure used to learn a pose classifier.

An accessible range of a physical memory of an actual computer may be restricted based on an Operating System (OS) and a memory addressing structure of hardware.

Additionally, to reduce an overhead swapped to a virtual memory, learning may need to be performed within a physical memory boundary. Accordingly, it is possible to efficiently reduce the learning time.

As such, according to example embodiments, only effective data in an image may be loaded in a memory and may be learned using an efficient data structure 920 of FIG. 9, instead of loading all data in an image array 910 in a memory and learning the loaded data.

Thus, a larger amount of learning data may be loaded and learned within a restricted physical memory space.

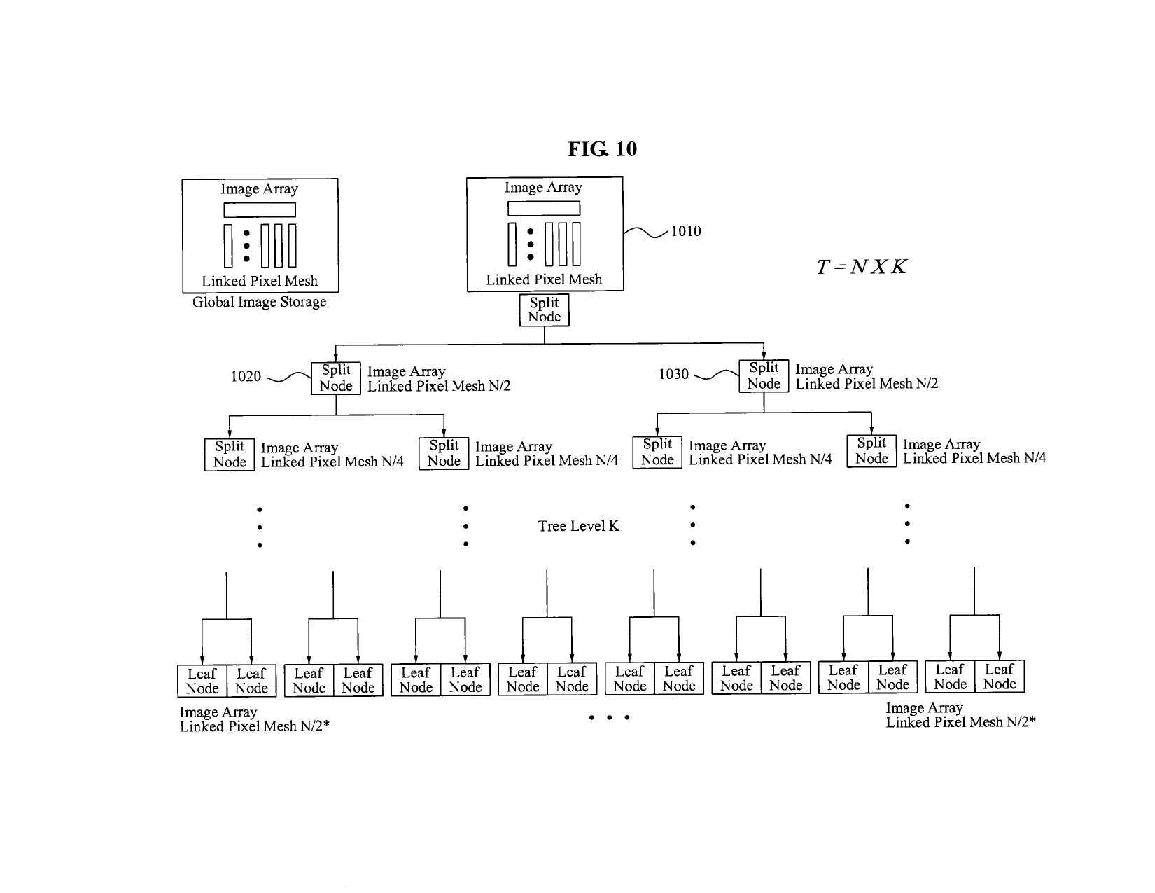

FIG. 10 illustrates a diagram to explain a method of transferring learning data when a single classifier is generated by a plurality of processes, according to example embodiments.

FIG. 10 illustrates a learning data passing method and a data management method to dynamically minimize a message usage of learning data in each stage of learning of a pose classifier and to maintain the minimized message usage, according to example embodiments.

First, two sets including learning data may be loaded, and may be learned using the same data structure as the data structure of FIG. 9, in an entire learning system.

In this instance, the data structure may not be limited to the data structure of FIG. 9.

One of the two sets may include data maintained at all times to calculate a feature, and may maintain the data in the same state in a global memory space during a lifetime of a learning system.

The other set 1010 may have a data structure to dynamically maintain only a residual learning target during learning of a tree. Data used while each stage of the learning is performed may be deleted from a memory, and only remaining data may be transferred to next stages, as indicated by reference numerals 1020 and 1030.

Accordingly, it is possible to minimize and optimize a memory usage, and to minimize a time required to learn a pose classifier.

For example, when a decision tree is used as a pose classifier, and when a level of the decision tree, a learning time of a root node, and a total learning time are indicated by K, N, and T, respectively, a time required for a typical learning method may be obtained as given in Equation 4 below.

Equation 4 may be based on the structure of FIG. 2 in which whole effective pixel passing is performed on only effective data.

T=N×2^{K} [Equation 4]

However, when a process of deleting data used in the learning from a memory and transferring only remaining data is used, a learning time in each tree level may be equal to or less than N, as shown in Equation 5 below, so that a tree learning time may be minimized.

T=N×K [Equation 5]

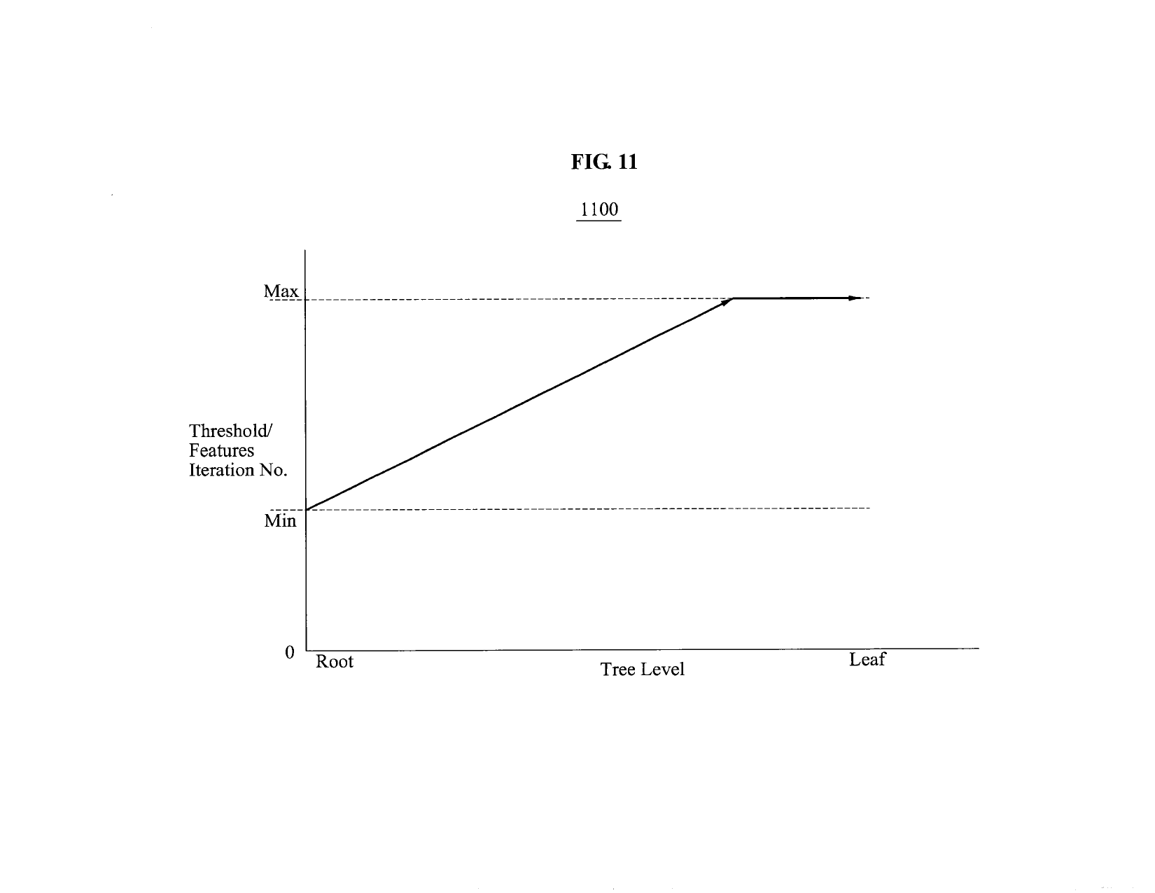

FIG. 11 illustrates a graph to explain a method of determining how many iterations are required to acquire an optimized learning result in each stage during generation of a single classifier, according to example embodiments.

In a graph 1100 of FIG. 11, when a decision tree is used as an object pose classifier, a pose classifier learning system, according to example embodiments, may iterate a small number of random features and thresholds, as closer to a root node, and may perform exhaustive iteration, as closer to a leaf node.

Thus, the pose classifier learning system may reduce the learning time, and may maintain a constant recognition performance.

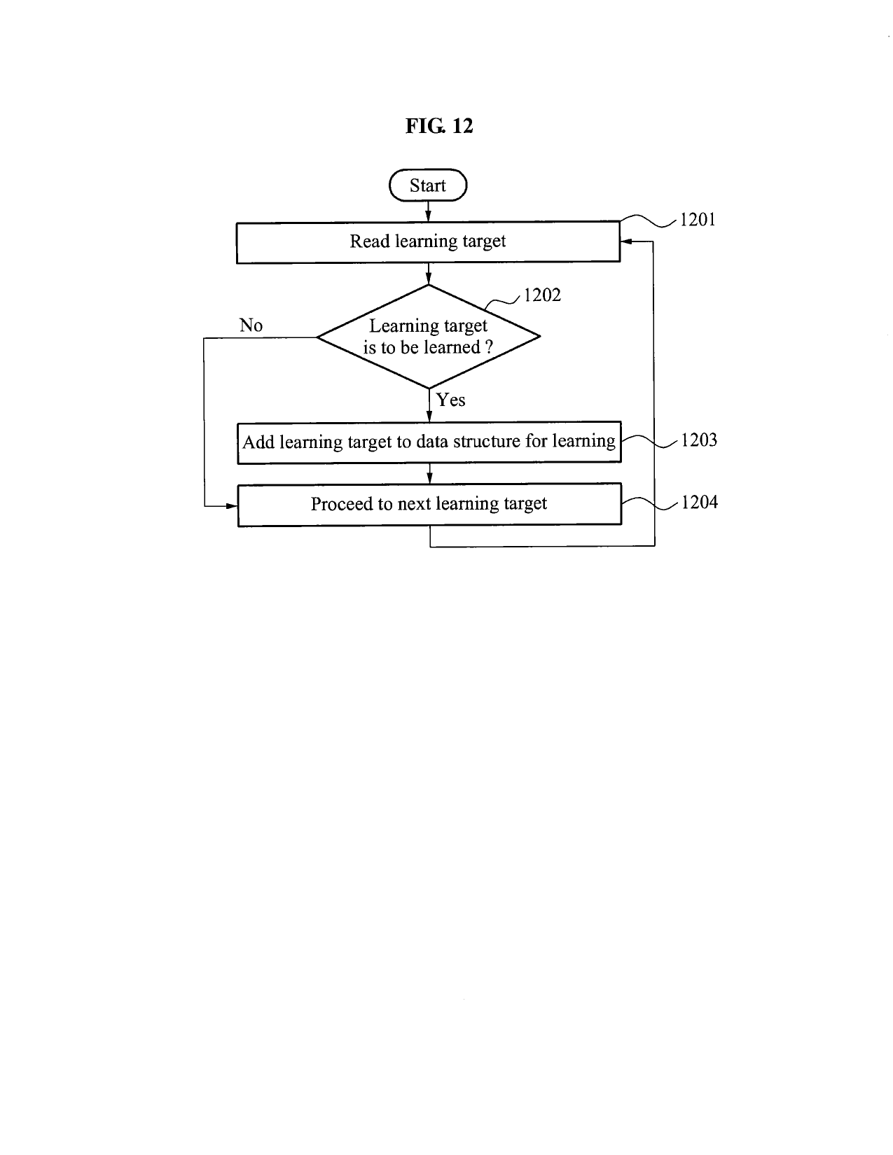

FIG. 12 illustrates a flowchart of the method of FIG. 7.

In an operation method of a pose classifier learning system, according to example embodiments, a plurality of pieces of learning data may be extracted from a plurality of pieces of image data, and an input of the extracted plurality of pieces of learning data may be received. A plurality of pose classifier learning devices may receive an input of a plurality of learning data sets including the plurality of pieces of learning data, and may learn each object pose classifier.

In this instance, only at least one data portion corresponding to a vertical line, a horizontal line, and a diagonal line, among data portions of each of the plurality of pieces of image data, may be extracted as the plurality of pieces of learning data. These example data portions are exemplary, and thus, the present disclosure is not limited thereto.

Referring to FIG. 12, in operation 1201, the plurality of pieces of learning data extracted from the plurality of pieces of image data may be read as a learning target. In operation 1202, whether or not the read learning target is to be learned may be determined.

For example, when the read learning target is determined to be learned, the learning target may be added to a data structure for learning in operation 1203, and the learning may proceed to a next learning target in operation 1204.

Conversely, when the read learning target is determined not to be learned, the learning may proceed to the next learning target in operation 1204.

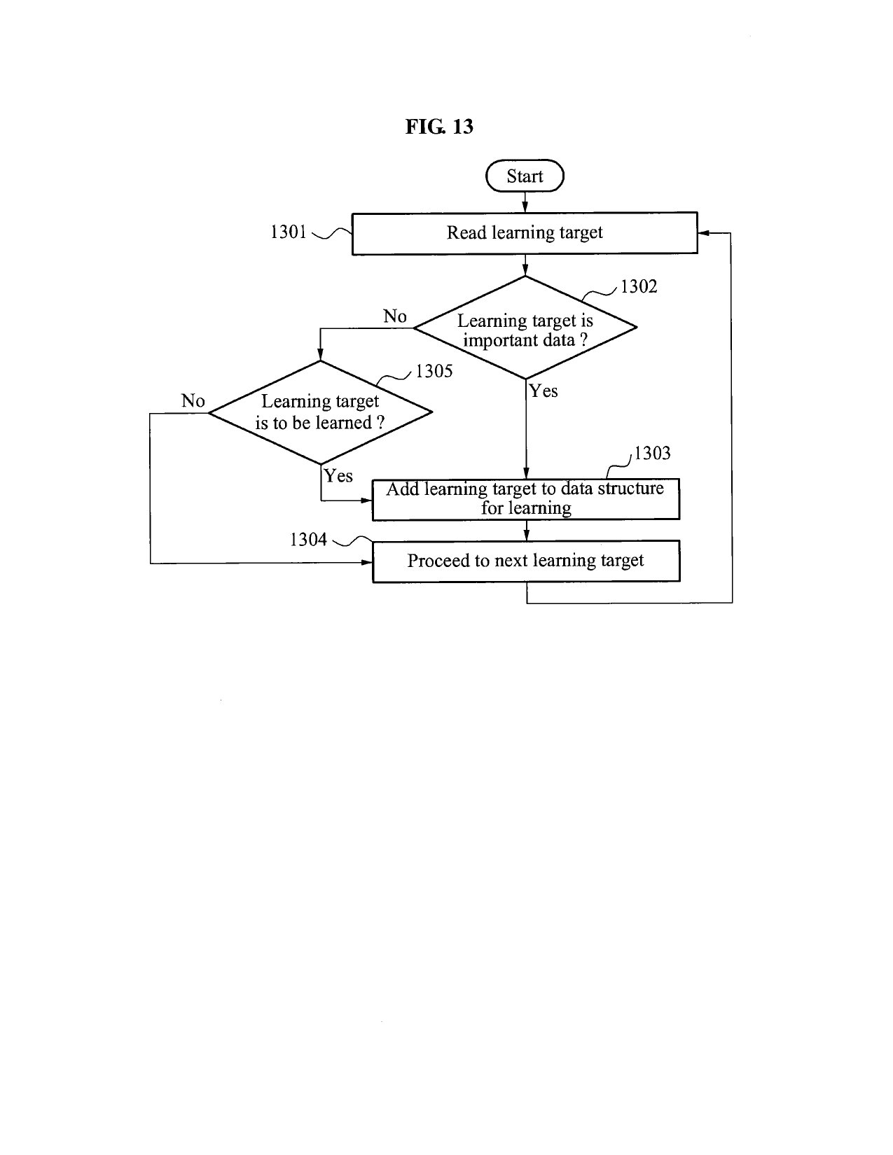

FIG. 13 illustrates a flowchart of the method of FIG. 8.

Referring to FIG. 13, in operation 1301, the plurality of pieces of learning data extracted from the plurality of pieces of image data may be read as a learning target. In operation 1302, whether or not the read learning target is important data may be determined.

For example, when the read learning target is determined to be important data, the learning target may be added to a data structure for learning in operation 1303, and the learning may proceed to a next learning target in operation 1304.

Conversely, when the read learning target is determined not to be important data, whether or not the read learning target is to be learned may be determined in operation 1305. When the learning target is determined to be learned, the learning target may be added to the data structure for learning in operation 1303. When the learning target is determined not to be learned, the learning may proceed to the next learning target in operation 1304.

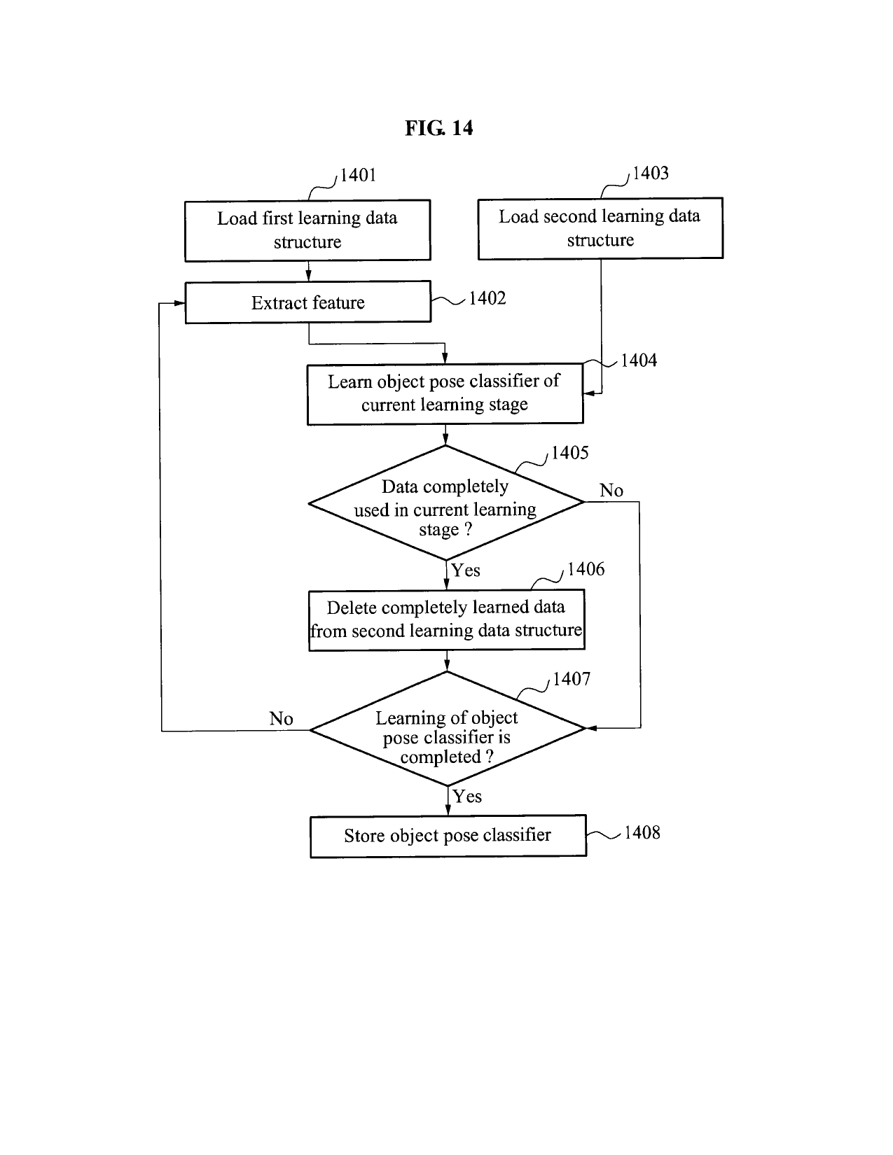

FIG. 14 illustrates a flowchart of processing of residual learning data, according to example embodiments.

Referring to FIG. 14, in operations 1401 and 1403, a first learning data structure, and a second learning data structure may be loaded in the same data structure as the data structure of FIG. 9 within an entire learning system, respectively.

In operation 1402, a feature may be extracted from the first learning data structure loaded in operation 1401.

In operation 1404, an object pose classifier of a current learning stage may be learned, using the feature extracted in operation 1402, and using the second learning data structure loaded in operation 1403.

In operation 1405, whether or not data is completely used in the current learning stage may be determined. When the result of operation 1405 is “Yes”, then the completely learned data may be deleted from the second learning data structure in operation 1406.

Conversely, when the result of operation 1405 is “No”, whether or not the learning of the object pose classifier is completed may be determined in operation 1407. When the learning of the object pose classifier is determined to be completed, the object pose classifier may be stored in 1408.

Conversely, when the learning of the object pose classifier is determined not to be completed, the processing may revert to operation 1402.

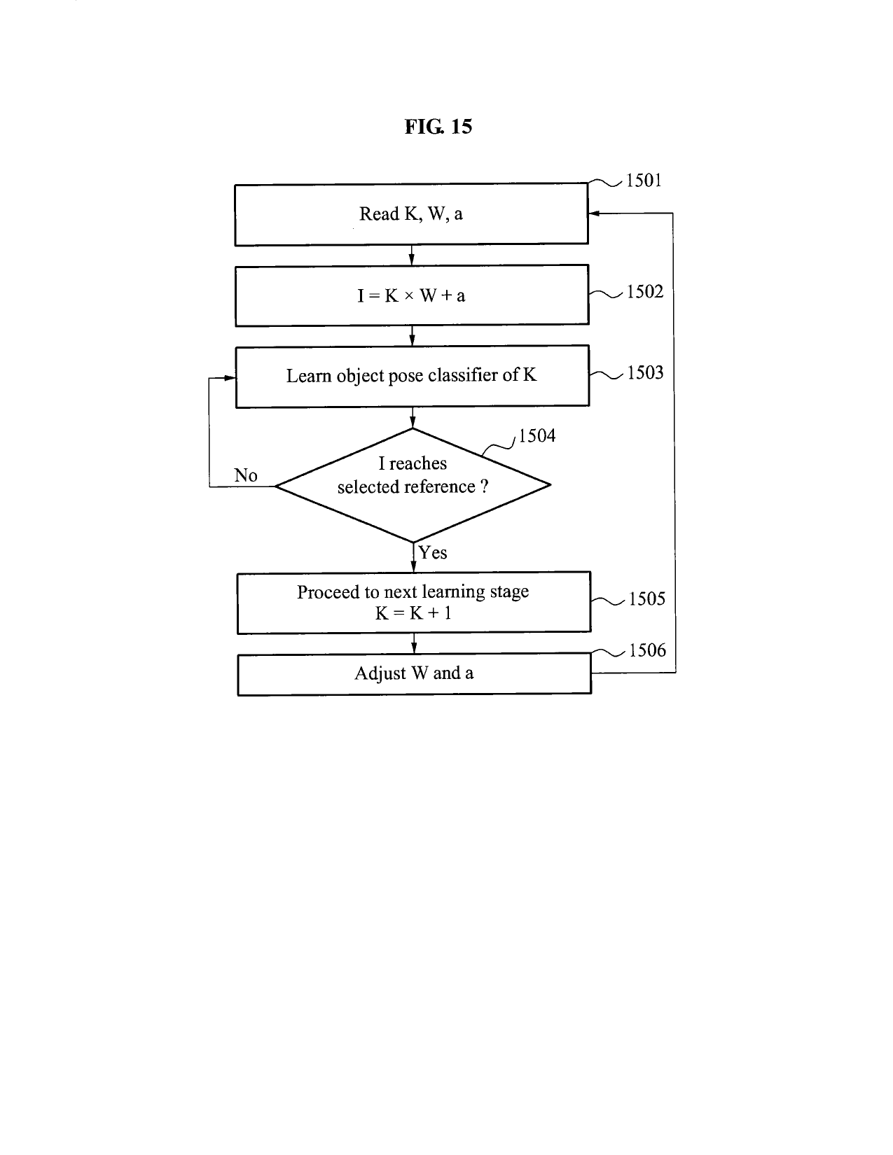

FIG. 15 illustrates a flowchart of the method of FIGS. 10 and 11.

Referring to FIG. 15, in operation 1501, a current learning level “K,” an increase and decrease based on a level “W,” and a minimum number of iterations “a” may be read.

In operation 1502, a number of iterations “I” may be computed using the following Equation 6:

I=K·W+a [Equation 6]

In operation 1503, an object pose classifier of the current learning level “K” may be learned. In operation 1504, whether a number of iterations “I” for learning reaches a selected reference may be determined.

When the number of iterations “I” is determined to reach the selected reference, the current learning level “K” may be incremented by “1” to proceed to a next learning stage in operation 1505.

When the number of iterations “I” is determined to fail to reach the selected reference in operation 1504, a value of “W” and a value of “a” may be adjusted as necessary in operation 1506, and the method may revert to operation 1501.

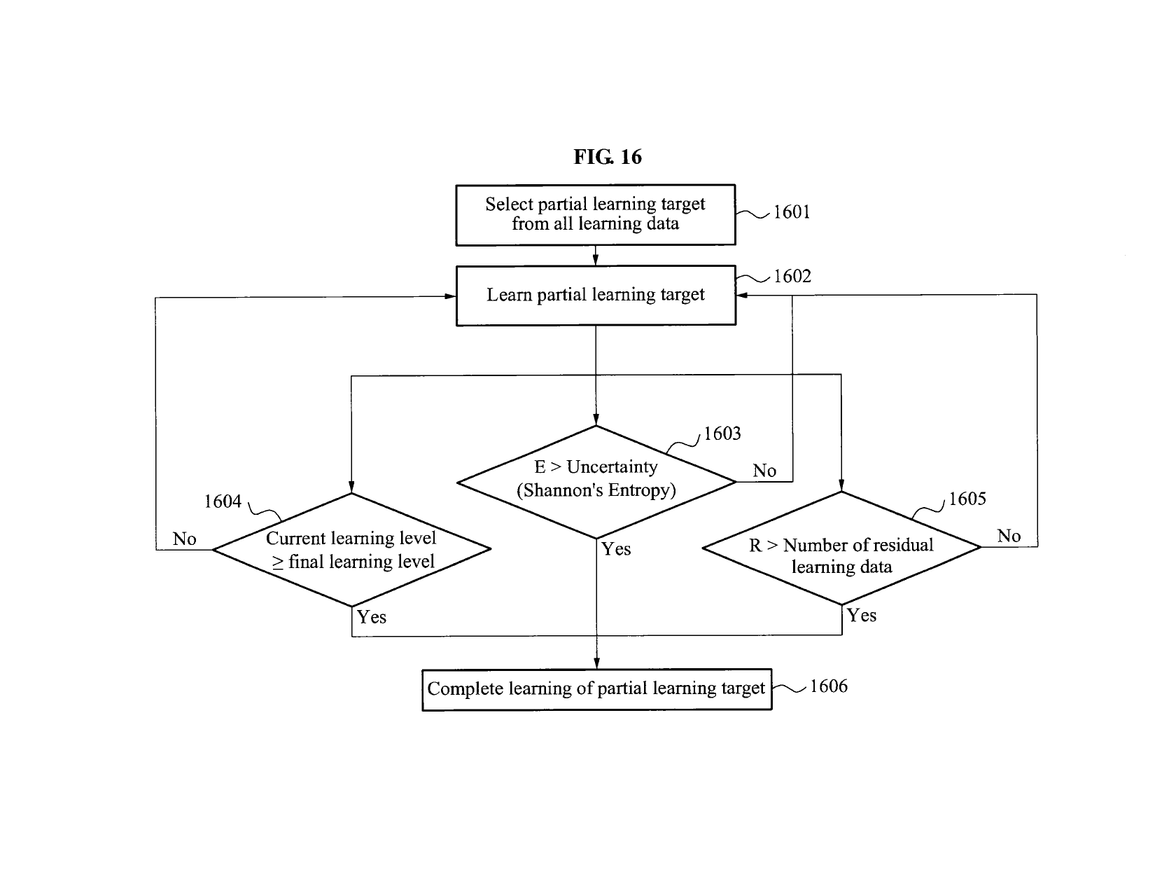

FIG. 16 illustrates a flowchart to further explain stopping criteria associated with learning of a pose classifier, according to example embodiments.

Referring to FIG. 16, in an operation method of a pose classifier learning system, according to example embodiments, whether or not learning of an object pose classifier is to proceed from each learning stage to a next learning stage may be determined.

During the learning of the object pose classifier in the pose classifier learning system, the object pose classifier may determine a time to stop the learning based on the stopping criteria. Additionally, over/under-fitting may be prevented through optimization of a stopping criteria parameter.

For example, when a decision tree is used as an object pose classifier, three stopping criteria may be provided, as follows:

1) An example in which an entropy of residual learning data is equal to or less than a predetermined level (for example, 0.5).

2) An example in which an amount of residual learning data is equal to or less than a predetermined level (for example, a number of portions of data is equal to or less than “10”).

3) An example in which a learning level reaches a predetermined level (for example, 25 levels).

Notably, the above stopping conditions are exemplary, and thus, the present disclosure is n operation 1601, a partial learning target may be selected from all learning data. In operation 1602, the selected partial learning target may be learned.

Through operations 1603 through 1605, the three stopping criteria may be determined.

In operation 1603, a determination may be made as to whether an entropy of residual learning data is greater than a predetermined level. In operation 1604, a determination may be made as to whether a current learning level is equal to or greater than a final learning level. In operation 1605, a determination may be made as to whether a number of residual learning data is less than a selected reference R.

When the entropy of the residual learning data is greater than the predetermined level, when the current learning level is equal to or greater than the final learning level, and when the number of the residual learning data is less than the selected reference R, learning of the partial learning target may be completed in operation 1606.

For example, when a decision tree is used as an object pose classifier, an actual value of a stopping criteria parameter may be found using the following process:

When a number of all learning data, and a number of target residual data of a terminal node are known, a maximum level of a tree that is required to be grown may be determined based on the following Equation 7:

$$D = {d}_{k} \times {2}^{k} \\ log ( D ) = log ( {d}_{k} ) + K \times log ( 2 ) \\ k = \frac{log ( D ) - log ( {d}_{k} )}{log ( 2 )} \qquad [ Equation 7 ]$$

In Equation 7, D denotes a number of all leaning target data, K denotes a maximum level of a tree, and dₖ denotes a number of learning target data in the maximum level K.

For example, when 100,000 images is assumed to have 3,200 pieces of learning target data on average, when a number of residual data is assumed to be 10 on average, and when balanced growing is assumed to performed on an object pose classifier, D, K, and dₖ may be computed as follows:

D=3,200×100,000=320,000,000, dₖ=10, K=24.932

When a number of all pieces of learning data, and a maximum learning level of an object pose classifier are known, an estimated number of residual data in a last stage may be determined as follows:

D=dₖ×2^{k}

log(D)=log(dₖ)+k×log(2)

log(dₖ)=log(D)−k×log(2)

dₖ=exp(log(D)−k×log(2))

In Equation 8, D denotes a number of all leaning target data, K denotes a maximum level of a tree, and dₖ denotes a number of learning target data in the maximum level K.

For example, when 100,000 images is assumed to have 3,200 pixels on average, when a level is assumed to be 20, and when balanced growing is performed on a tree, D, K, and dₖ may be computed as follows:

D=3,200×100,000=320,000,000, K=26, and dₖ=4.768

When a minimum number of data is used in a lowest level, dₖ may be computed to be 9.536 that is double 4.768.

For example, when a decision tree is used as an object pose classifier, and when a number of target residual data of a terminal node is obtained, a threshold of a Shannon's entropy may be computed, as given in the following Equation 9:

$${lp}_{i} = \frac{{LB}_{i}}{{\sum }_{i = 1}^{bp} {LB}_{i}} , {rp}_{i} = \frac{{RB}_{i}}{{\sum }_{i = 1}^{bp} {RB}_{i}} \\ {E}_{l} = - {\sum }_{i = 1}^{bp} {lp}_{i} \times log ( {lp}_{i} ) {E}_{r} = - {\sum }_{i = 1}^{bp} {rp}_{i} \times log ( {rp}_{i} ) \\ α = \frac{{\sum }_{i = 1}^{bp} {LB}_{i}}{{\sum }_{i = 1}^{bp} {LB}_{i} + {\sum }_{i = 1}^{bp} {RB}_{i}} \\ E = α \times {E}_{l} + ( 1 - α ) \times {E}_{r} \qquad [ Equation 9 ]$$

In Equation 9, D denotes a number of all leaning target data, K denotes a maximum level of a tree, d denotes a number of learning target data in the maximum level K, by denotes a number of body parts, LB denotes a set of portions of data split to the left, RB denotes a set of portions of data split to the right, and α denotes a weight.

For example, it may be assumed that by is “31” in a maximum bound of a terminal node, that d, LB, and RB of the terminal node are “5,” and that all Ip₁ and rp₁ are equal to each other to obtain a highest impurity.

In this example, when by is greater than d, Ip₁, rp₁, E₁, Eᵣ, and α may be computed to be “1/d,” “1/d,” “1.609,” “1.609,” and “0.5,” respectively. E may be computed to be “1.609” by “0.5×1.609+(1−0.5)×1.609.”

Additionally, when by is less than d, Ip₁, ro₁, E₁, Eᵣ, and a may be computed to be “1/bp,” “1/bp,” “3.434,” “3.434,” and “0.5,” respectively. E may be computed to be “3.434” by “0.5×3.434+(1−0.5)×3.434.”

For example, it may be assumed that by is “31” in a minimum bound of a terminal node, that d, LB, and RB of the terminal node are “5,” “8,” and “2,” respectively, and that a probability of a predetermined Ip₁ and rp₁ is high, to obtain a lowest impurity,

When P1 and P2 are “0.8” and “0.2,” respectively, E may be computed to be “0.5” using Equation 9.

The operation method of the pose classifier learning system according to the above-described example embodiments may be recorded in non-transitory computer-readable media including program instructions to implement various operations embodied by a computer. The media may also include, alone or in combination with the program instructions, data files, data structures, and the like. The results produced can be displayed on a display of the computing hardware. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

According to example embodiments, it is possible to simultaneously learn at least hundreds of thousands of images, by minimizing a memory usage required for learning.

Additionally, according to example embodiments, it is possible to minimize a learning time required to simultaneously learn at least hundreds of thousands of images, and to ensure a required recognition performance using a classifier obtained by the learning.

Further, according to an aspect of the embodiments, any combinations of the described features, functions and/or operations can be provided.

Moreover, the pose classifier learning system may include at least one processor to execute at least one of the above-described units and methods.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A pose classifier learning system, comprising:
an input unit to receive an input of a plurality of pieces of learning data; and
a plurality of pose classifier learning devices to receive an input of a plurality of learning data sets, the data sets including the inputted plurality of pieces of learning data, and to learn each of plural pose classifiers,
wherein the pose classifier learning devices share learning information in each stage, using a distributed/parallel framework.

2. The pose classifier learning system of claim 1, further comprising:
a learning data extracting unit to obtain the plurality of pieces of learning data by extracting the plurality of pieces of learning data from a plurality of pieces of image data.

3. The pose classifier learning system of claim 1, wherein the learning data extracting unit extracts, as the plurality of pieces of learning data, at least one data portion, among data portions, corresponding to a vertical line, a horizontal line, and a diagonal line of each of the plurality of pieces of image data.

4. The pose classifier learning system of claim 1, wherein the learning data extracting unit applies a weight to the extracted plurality of pieces of learning data.

5. The pose classifier learning system of claim 1, wherein the pose classifier learning devices simultaneously learn the plurality of pieces of learning data, using a data structure, in which effective data that is used for distributed learning is managed in a physical memory.

6. The pose classifier learning system of claim 1, wherein the pose classifier learning devices simultaneously learn the plurality of pieces of learning data, using a structure in which effective data that is used for distributed learning is transferred to each stage of learning.

7. The pose classifier learning system of claim 1, wherein the pose classifier learning devices dynamically adjust, based on a number of stages of the learning, a number of iterations to search for an optimized result in each learning stage of the pose classifier.

8. The pose classifier learning system of claim 1, wherein the pose classifier learning devices determine whether or not learning is to proceed to a next stage, based on at least one of an entropy of residual learning data, an amount of the residual learning data, and a progress of the learning.

9. An operation method of a pose classifier learning system, the operation method comprising:
receiving an input of a plurality of pieces of learning data; and
receiving, by a plurality of pose classifier learning devices, an input of a plurality of learning data sets, the data sets including the plurality of pieces of learning data, and learning each of plural pose classifiers,
wherein the pose classifier learning devices share learning information in each stage, using a distributed/parallel framework.

10. The operation method of claim 9, further comprising:
obtaining the plurality of pieces of learning data by extracting the plurality of pieces of learning data from a plurality of pieces of image data.

11. The operation method of claim 10, wherein the extracting comprises extracting, as the plurality of pieces of learning data, at least one data portion, among data portions, corresponding to a vertical line, a horizontal line, and a diagonal line of each of the plurality of pieces of image data.

12. The operation method of claim 10, wherein the extracting comprises applying a weight to the extracted plurality of pieces of learning data.

13. A non-transitory computer readable recording medium storing a program to cause a computer to implement the method of claim 9.

14. A method for reducing a learning time for learning images, the method comprising:
reading, by a processor, a learning target by extracting a data portion from each of a plurality of pieces of image data;
storing the learning target in a data structure for learning; and
learning, in parallel by each of a plurality of pose classifier learning devices, a single pose classifier, using the read learning target.

15. The method of claim 14, wherein the data portion from each of the plurality of pieces of image data is at least one data portion, among data portions, corresponding to a vertical line, a horizontal line, and a diagonal line of each of the plurality of pieces of image data.

16. The method of claim 14, wherein the learning comprises learning important parts of an object in learning data.

17. The method of claim 16, wherein the important parts of the object in the learning data comprises data regarding a body part that frequently moves.

18. The method of claim 16, wherein the important parts of the object include at least one of hands and feet.

19. The method of claim 14, wherein a plurality of processes generates a single pose classifier.

20. The method of claim 19, wherein communicating between the plurality of processes occurs, such that one process is a process coordinator and the remaining processes communicate as attendees.
